(19) United States
(12) Patent Application Publication
(10) Pub. No.: US 2021/0090836 A1
(43) Pub. Date: Mar. 25, 2021

(54) ELECTROMAGNETIC RELAY

(71) Applicant: OMRON Corporation, Kyoto-shi (JP)

(72) Inventors: Kohei OTSUKA, Omuta-shi (JP); Ryota MINOWA, Yamaga-shi (JP); Hiroyuki IWASAKA, Kamimashiki-gun (JP); Hiroyuki HARIMOCHI, Kumamoto-shi (JP); Shinichi OGAWA, Kikuchi-shi (JP); Naoki KAWAGUCHI, Yame-shi (JP)

(73) Assignee: OMRON Corporation

(21) Appl. No.: 17/012,059

(22) Filed: Sep. 4, 2020

(30) Foreign Application Priority Data
Sep. 19, 2019 (JP) 2019-170896

(51) Int. Cl. H01H 50/54; H01H 50/04; H01H 50/18; H01H 50/14

(52) U.S. Cl. CPC H01H 50/54; H01H 50/14; H01H 50/18; H01H 50/04

(57) ABSTRACT

A pair of fixed terminals each include an internal terminal, an external terminal, and fixed contact. The internal terminal is located inside the housing. The external terminal includes an external connection portion and protrudes outward from a housing. The housing includes a side portion extending in a moving direction of a movable contact piece. The external terminal is arranged without protruding outwardly in a width direction of the pair of fixed terminals beyond both ends of the side portion in the width direction of the pair of fixed terminals at a height position of the external terminal in the moving direction. The external connection portion is formed to be larger than the internal terminal in at least one of the width direction or a thickness direction of the pair of fixed terminals.

### CROSS-REFERENCE TO RELATED APPLICATION

This application claims priority to Japanese Patent Application No. 2019-170896, filed Sep. 19, 2019. The contents of that application are incorporated by reference herein in their entirety.

### FIELD

The present invention relates to an electromagnetic relay.

### BACKGROUND

Conventionally, an electromagnetic relay that opens and closes an electric circuit is known. The electromagnetic relay described in Japanese Laid-Open Patent Publication No. 2019-083175 is a plunger-type electromagnetic relay in which fixed terminal including fixed contact is plate-shaped terminal.

### SUMMARY

In an electromagnetic relay, the current-carrying capacity decreases due to heat generation during energization, so it is necessary to efficiently dissipate heat generation during energization to the outside.

An object of the present invention is to provide an electromagnetic relay having excellent heat dissipation in the electromagnetic relay including fixed terminal having a plate shape.

An electromagnetic relay according to one aspect of the present invention includes a housing, a pair of fixed terminals, a movable contact piece, a drive shaft, and a drive device. The pair of fixed terminals have a plate shape. The pair of fixed terminals each include an internal terminal, an external terminal, and fixed contact. The internal terminal is located inside the housing. The external terminal includes an external connection portion and protrudes outward from the housing. The movable contact piece includes a pair of movable contacts arranged facing the fixed contact. The movable contact piece is configured to move in a moving direction including a contact direction in which the pair of movable contacts comes into contact the fixed contact and a separation direction in which the pair of movable contacts separates from the fixed contact. The drive shaft coupled to the movable contact piece. The drive device is configured to move the movable contact piece through the drive shaft. The housing includes a side portion extending in the moving direction of the movable contact piece. The external terminal is arranged without protruding outwardly in a width direction of the pair of fixed terminals beyond both ends of the side portion in the width direction of the pair of fixed terminals at a height position of the external terminal in the moving direction. The external connection portion is formed to be larger than the internal terminal in at least one of the width direction or a thickness direction of the pair of fixed terminals.

With the relay according to this aspect, the external connection portion of the external terminal is formed to be larger than the internal terminal in at least one of the width direction or the thickness direction of the fixed terminal. As a result, the surface area of the fixed terminal exposed to the outside becomes larger than that in the case where the fixed terminal is configured with a uniform width and a uniform thickness. Thereby, the heat generated by the fixed terminal during energization can be effectively released to the outside of the housing. That is, the heat dissipation of the electromagnetic relay can be improved by the external connection portion of the fixed terminal. This makes it possible to provide an electromagnetic relay having excellent heat dissipation in the electromagnetic relay including the fixed terminal having a plate shape.

Further, for example, since the contact area with another terminal connected to the external connection portion is increased, the heat dissipation is further improved and stable contact with another terminal can be secured. Further, since the external terminal is arranged without protruding outwardly in the width direction of the pair of fixed terminals beyond both ends of the side portion in the width direction of the pair of fixed terminals, compared to the case where the external terminal protrudes outward in the width direction from the side portion, the space around the side portion is less likely to be interfered by the external terminal. Thereby, the space around the side portion can be effectively utilized.

The external terminal may include a connection portion that connects the internal terminal and the external connection portion. A dimension of the connection portion in the width direction may be smaller than a dimension of the external connection portion in the width direction.

The external terminal may include a connection portion that connects the internal terminal and the external connection portion. A dimension of the connection portion in the thickness direction may be smaller than a dimension of the external connection portion in the thickness direction.

The external connection portion may include a fixing portion for fixing another terminal, and have a contact area of 0.4 r or more around the fixing portion in a case where a radius of the fixing portion is defined r. In this case, a contact area equal to or larger than the area of the fixing portion can be secured when another terminal 30 is brought into contact with and connected to the external connection portion, so that stable contact with another terminal is ensured.

The fixing portion may be a circular hole penetrating in the thickness direction.

The fixing portion may be a male screw portion extending in the thickness direction.

### BRIEF DESCRIPTION OF THE DRAWINGS

FIG. 1 is a schematic sectional view of an electromagnetic relay.

FIG. 2 is a schematic view of the electromagnetic relay as viewed from above.

FIG. 3 is a schematic diagram when another terminal is connected to an external connection portion.

FIG. 4 is a schematic view of a fixed terminal as viewed from above.

FIG. 5 is a schematic sectional view of an electromagnetic relay according to another embodiment.

FIG. 6 is a schematic sectional view of an electromagnetic relay according to another embodiment.

FIG. 7 is a schematic sectional view of an electromagnetic relay according to another embodiment.

### DETAILED DESCRIPTION

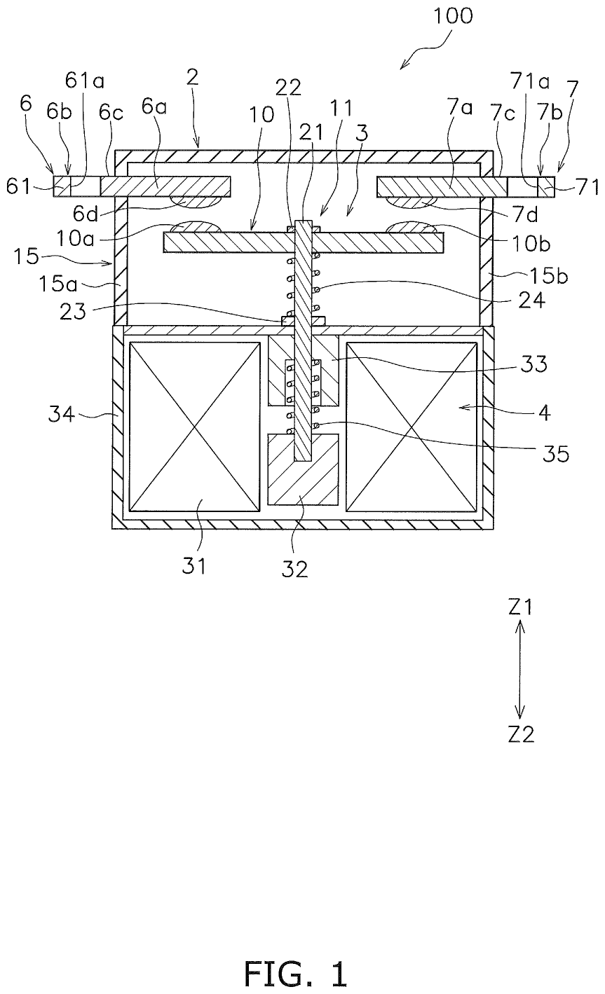

Hereinafter, embodiment of an electromagnetic relay according to one aspect of the present invention will be described with reference to the drawings. FIG. 1 is a schematic sectional view of an electromagnetic relay 100. As illustrated in FIG. 1, the electromagnetic relay 100 includes a housing 2, a contact device 3, and a drive device 4.

When referring to the drawings, an upper side in FIG. 1 is referred to as “up”, a lower side is referred to as “down”, a left side is referred to as “left”, and a right side is referred to as “right” in order to facilitate understanding of the description. Further, a front side of the paper surface of FIG. 1 is referred to as “front”, and back side of the paper surface of FIG. 1 is referred to as “back”. These directions are defined for convenience of explanation, and do not limit an arrangement direction of the electromagnetic relay 100.

The housing 2 has a substantially rectangular box shape and is made of an insulating material. The contact device 3 and the drive device 4 are housed inside the housing 2.

The housing 2 includes a side portion 15 extending in a moving direction of a described later movable contact piece 10. Here, the side portion 15 extends in the up-down direction.

The side portion 15 includes a left side portion 15a, a right side portion 15b, a front side portion 15c, and a back side portion 15d. The left side portion 15a and the right side portion 15b extend in the up-down direction and the front-back direction, and are arranged facing each other in the left-right direction. The front side portion 15c and the r side portion 15d extend in the up-down direction and the left-right direction, and are arranged facing each other in the front-back direction.

The contact device 3 includes fixed terminals 6, 7, the movable contact piece 10, and a movable mechanism 11. The fixed terminals 6, 7 are an example of a pair of fixed terminals.

The fixed terminals 6, 7 are plate-shaped terminals and are made of a conductive material. The fixed terminals 6, 7 extend in the left-right direction. The fixed terminal 6 is arranged at a distance from the fixed terminal 7 in the left-right direction.

The fixed terminal 6 includes an internal terminal 6a, an external terminal 6b, a connection portion 6c, and a fixed contact 6d. The internal terminal 6a is located inside the housing 2. The external terminal 6b protrudes from the housing 2 to the outside. Specifically, the external terminal 6b protrudes from the side portion 15 to the outside of the housing 2. In this embodiment, the external terminal 6b protrudes from the left side portion 15a.

At the height position of the external terminal 6b in the moving direction of the movable contact piece 10, the external terminal 6b is arranged so as not to protrude outwardly in a width direction of the fixed terminal 6 beyond both ends E1 of the left side portion 15a in the width direction of the fixed terminal 6 at a height position of the external terminal 6b in the moving direction. That is, both ends E1 of the side portion 15 are located outwardly in the width direction more than the external terminal 6b at the same height position as the external terminal 6b in the moving direction of the movable contact piece 10. In this embodiment, the width direction matches the front-back direction. Further, outwardly in the width direction means, in the width direction, a direction away from the center of the fixed terminal 6 in the width direction. In this embodiment, the entire external terminal 6b is arranged so as not to protrude outwardly in the width direction more than both ends E1 of the left side portion 15a in the width direction.

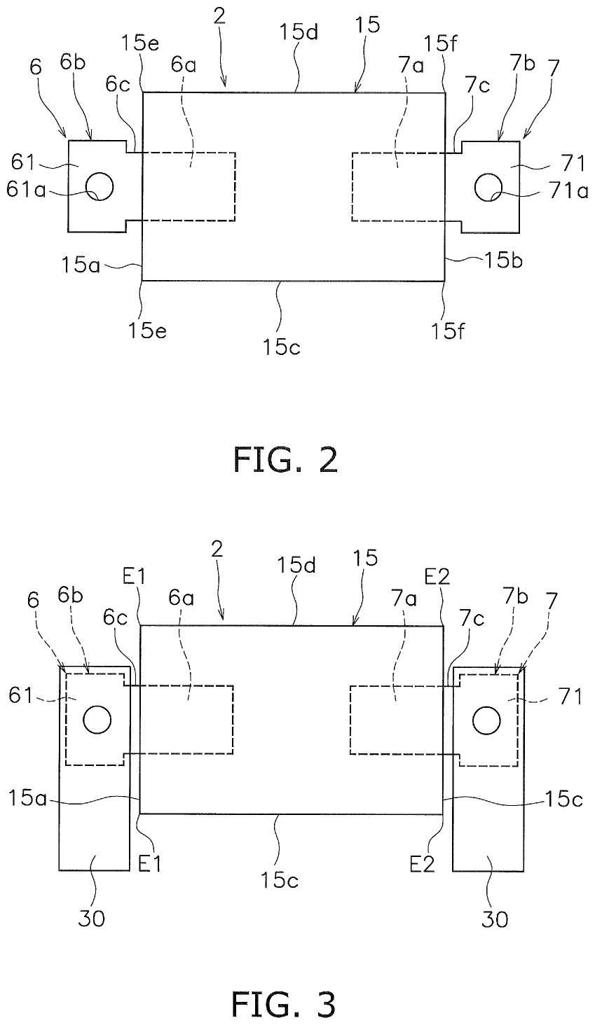

The external terminal 6b includes an external connection portion 61. The external connection portion 61 is connected to another terminal 30 such as a bus bar as illustrated in FIG. 3. The external connection portion 61 is formed to be larger than the internal terminal 6a in at least one of the width direction or a thickness direction of the fixed terminal 6. In this embodiment, the thickness direction matches the up-down direction. In this embodiment, as illustrated in FIG. 2, the external connection portion 61 is formed to be larger than the internal terminal 6a in the width direction. That is, a dimension of the external connection portion 61 in the width direction is larger than a dimension of the internal terminal 6a in the width direction. Note that, the thickness of the external connection portion 61 is equivalent to the thickness of the internal terminal 6a.

The external connection portion 61 includes a fixing portion 61a for fixing another terminal 30. The fixing portion 61a is a circular hole that penetrates in the thickness direction of the fixed terminal 6. A fixing member such as a bolt (not illustrated) is passed through the fixing portion 61a, and another terminal 30 is fixed to the external connection portion 61 by the fixing member.

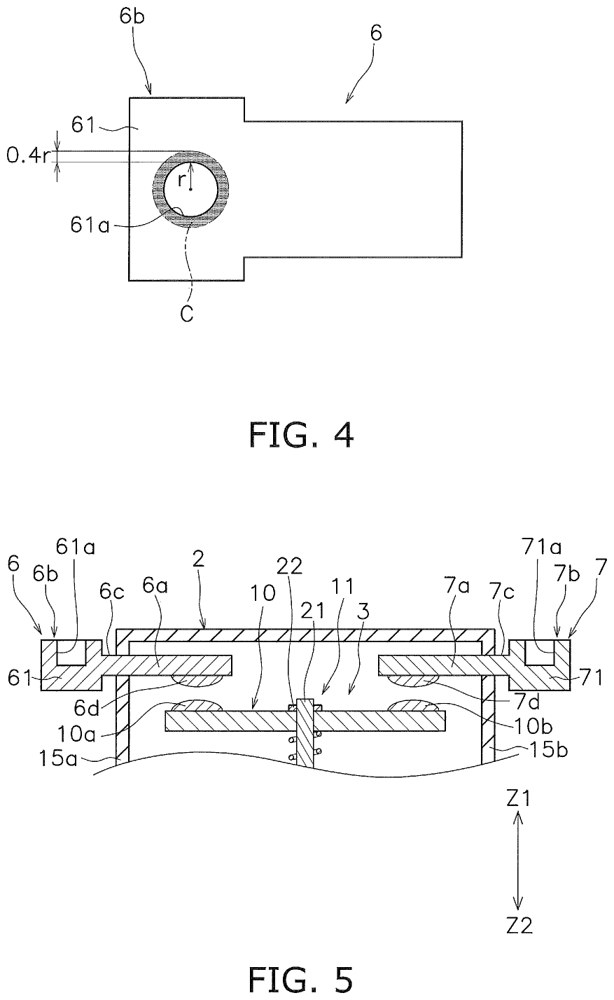

As illustrated in FIG. 4, the external connection portion 61 preferably has a contact area A of 0.4 r or more around the fixing portion 61a in a case where a radius of the fixing portion 61a is defined as r. The contact area A is an area where the fixing portion 61a contacts another terminal 30 when the fixing portion 61a is fixed to another terminal 30. Due to this configuration, a contact area equal to or larger than an area of the fixing portion 61a can be secured when another terminal 30 is brought into contact with and connected to the external connection portion 61, so that stable contact with another terminal 30 is ensured.

The connection portion 6c connects the internal terminal 6a and the external connection portion 61. The connection portion 6c is integrated with the internal terminal 6a and the external terminal 6b. A dimension of the connection portion 6c in the width direction is smaller than a dimension of the external connection portion 61 in the width direction. That is, a front-back dimension of the external connection portion 61 is larger than a front-back dimension of the internal terminal 6a. The dimension of the connection portion 6c in the width direction is equivalent to the dimension of the internal terminal 6a in the width direction. A thickness of the connection portion 6c is equivalent to the thickness of the internal terminal 6a.

The fixed contact 6d is made of a conductive material. The fixed contact 6d is arranged in the housing 2. The fixed contact 6d is arranged on the internal terminal 6a. The fixed contact 6d is provided separately from the fixed terminal 6. The fixed contact 6d may be integrated with the fixed terminal 6.

The fixed terminal 7 includes an internal terminal 7a, an external terminal 7b, a connection portion 7c, and a fixed contact 7d. The external terminal 7b includes an external connection portion 71. The external connection portion 71 includes a fixing portion 71a. Since the fixed terminal 7 has a bilaterally symmetrical shape with the fixed terminal 6 across a described later drive shaft 21, detailed description of each of these configurations will be omitted. Note that, the external terminal 7b is arranged so as not to protrude outwardly in the width direction beyond both ends E2 of the right side portion 15b in the width direction at a height position of the external terminal 7b in the moving direction of the movable contact piece 10.

The movable contact piece 10 is a plate shape member that is long in one direction, and extends in the left-right direction inside the housing 2. In this embodiment, a longitudinal direction of the movable contact piece 10 matches the left-right direction. Moreover, a lateral direction of the movable contact piece 10 matches the front-back direction. The movable contact piece 10 is made of a conductive material.

The movable contact piece 10 includes movable contacts 10a, 10b. The movable contacts 10a, 10b are an example of a pair of movable contacts. The movable contact 10a is arranged at a position facing the fixed contact 6d and can contact the fixed contact 6d. The movable contact 10b is arranged at a distance in the left-right direction from the movable contact 10a. The movable contact 10b is arranged at a position facing the fixed contact 7d and can contact the fixed contact 7d. The movable contacts 10a, 10b are made of a conductive material. The movable contacts 10a, 10b are separate bodies from the movable contact piece 10. Note that, the movable contacts 10a, 10b may be integrated with the movable contact piece 10.

The movable contact piece 10 is configured to move in the moving direction including in a contact direction Z1 in which the movable contacts 10a, 10b contact the fixed contacts 6d, 7d and a separation direction Z2 in which the movable contacts 10a, 10b separate from the fixed contacts 6d, 7d. The contact direction Z1 is the upper side in FIG. 1. The separation direction Z2 is the lower side in FIG. 1. Therefore, the contact direction Z1 and the separation direction Z2 are parallel to the up-down direction. The contact direction Z1 and the separation direction Z2 are examples of the moving direction of the movable contact piece 10.

The movable mechanism 11 supports the movable contact piece 10. The movable mechanism 11 is provided so as to be movable to a closed position where the fixed contacts 6d, 7d and the movable contacts 10a, 10b contact each other, and to an open position where the fixed contacts 6d, 7d and the movable contacts 10a, 10b separate from each other. That is, the movable mechanism 11 is provided so as to be movable in the contact direction Z1 and the separation direction Z2.

The movable mechanism 11 includes the drive shaft 21, a first holding member 22, a second holding member 23, and a contact spring 24. The drive shaft 21 is coupled to the movable contact piece 10. The drive shaft 21 extends in the up-down direction and penetrates the movable contact piece 10 in the up-down direction. The drive shaft 21 is provided so as to be movable in the contact direction Z1 and the separation direction Z2.

The first holding member 22 is fixed to the drive shaft 21 on the contact direction Z1 side more than the movable contact piece 10. The first holding member 22 can contact the movable contact piece 10. The second holding member 23 is fixed to the drive shaft 21 on the separation direction Z2 side more than the movable contact piece 10. The contact spring 24 is arranged between the movable contact piece 10 and the second holding member 23. The contact spring 24 biases the movable contact piece 10 in the contact direction Z1 through the second holding member 23.

The drive device 4 moves the movable mechanism 11 between the closed position and the open position by the electromagnetic force. The drive device 4 moves the movable contact piece 10 in the contact direction Z1 and the separation direction Z2 through the drive shaft 21. The drive device 4 includes a coil 31, a movable iron core 32, a fixed core 33, a yoke 34, and a return spring 35.

When a voltage is applied and the coil 31 is excited, the coil 31 generates the electromagnetic force that moves the movable iron core 32 in the contact direction Z1. The movable iron core 32 is coupled to the drive shaft 21 so as to be integrally movable. The fixed core 33 is arranged at a position facing the movable iron core 32. The yoke 34 is arranged so as to surround the coil 31. The return spring 35 is arranged between the movable iron core 32 and the fixed core 33. The return spring 35 biases the movable iron core 32 in the separation direction Z2.

In the electromagnetic relay 100 configured as described above, the external connection portion 61 of the external terminal 6b is formed larger than the internal terminal 6a in at least one of the width direction or the thickness direction. As a result, the surface area of the fixed terminal 6 exposed to the outside becomes larger than that in the case where the fixed terminal 6 has a uniform width and a uniform thickness. Thereby, the heat generated by the fixed terminal 6 during energization can be effectively released to the outside of the housing 2. That is, the heat dissipation of the electromagnetic relay 100 can be improved by the external connection portion 61 of the fixed terminal 6. Consequently, in the electromagnetic relay 100 including the fixed terminal 6 having a plate shape, it is possible to provide an electromagnetic relay excellent in heat dissipation. Note that, in the fixed terminal 7, the heat dissipation of the electromagnetic relay 100 can be improved by the external connection portion 71.

Further, since the contact area with another terminal 30 connected to the external connection portion 61 is increased, the heat dissipation is further improved and stable contact with another terminal 30 can be secured. Further, since the external terminal 6b is arranged without protruding outwardly in the width direction beyond both ends E1 of the left side portion 15a in the width direction, compared to the case where the external terminal 6b protrudes outwardly in the width direction from the side portions 15, spaces around both ends of the side portion 15 in the width direction are less likely to be interfered by the external terminal 6b. Thereby, the space around both ends of the side portion 15 in the width direction can be effectively utilized.

While the embodiment of the electromagnetic relay according to one aspect of the present invention has been described, the present invention should not be construed as being limited thereto, and various types of modifications may be made without departing from the spirit or scope of the general inventive concept of the invention.

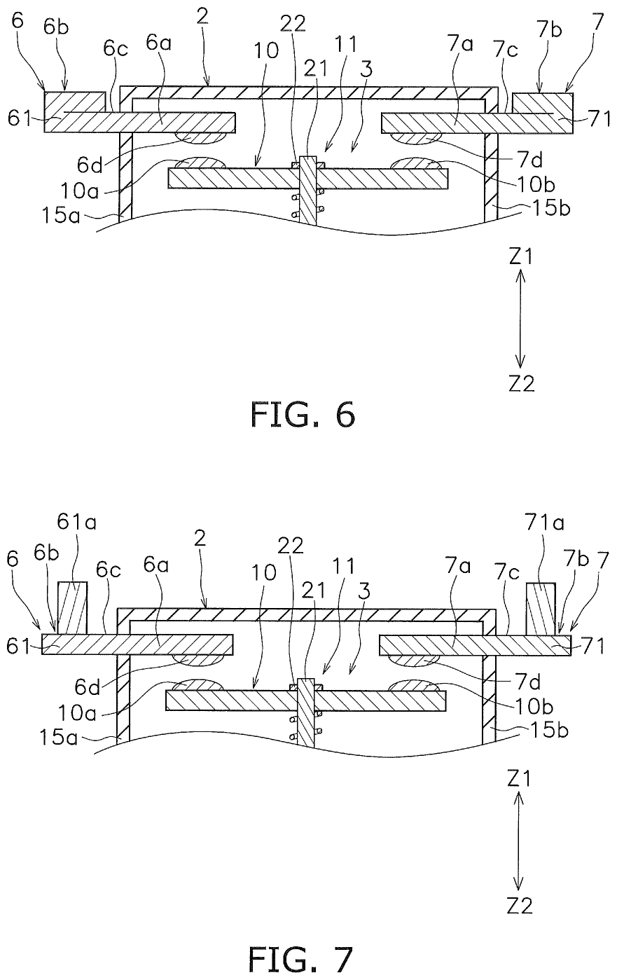

The shapes of the external connection portions 61, 71 are not limited to those in the above embodiment. For example, as illustrated in FIG. 5, the external connection portions 61, 71 may be formed to be larger than the internal terminals 6a, 7a in the thickness direction. That is, the dimensions of the external connection portions 61, 71 in the thickness direction may be larger than the dimensions of the internal terminals 6a, 7a in the thickness direction. Alternatively, the external connection portions 61, 71 may be formed larger than the internal terminals 6a, 7a in the width direction and the thickness direction. Further, as illustrated in FIG. 6, the external connection portions 61, 71 may be formed to be larger than the internal terminals 6a, 7a in the thickness direction by bending the external terminals 6b, 7b of the fixed terminals 6, 7.

The fixing portions 61a, 71a are not limited to the hole shape. For example, the fixing portions 61a, 71a may be configured by a flat surface having no holes. Further, as illustrated in FIG. 5, the fixing portions 61a, 71a may be threaded holes having internal threads formed on the inner peripheral surface thereof. Further, as illustrated in FIG. 7, the fixing portions 61a, 71a may be male screw portions extending in the thickness direction. For example, the fixing portions 61a, 71a may be configured by bolts or the like joined to the external connection portions 61, 71. In this case, when the radius of the male screw portion is r, it is preferable that the external connection portions 61, 71 have a contact area A of 0.4 r or more around the male screw portion.

In the above-described embodiment, the fixed terminal 6 and the fixed terminal 7 are symmetrical to the left and right with respect to the drive shaft 21, but the fixed terminal 6 and the fixed terminal 7 do not necessarily have to be symmetrical to the left and right. For example, it may be symmetrical in the left-right direction and the front-back direction. Further, although the fixing portions 61a, 71a are formed near the center of the external connection portions 61, 71, the fixing portions 61a, 71a may be formed at positions displaced in a predetermined direction.

In the above-described embodiment, the electromagnetic relay is configured to push the movable contacts 10a, 10b toward the fixed contacts 6d, 7d, but the present invention may be applied to the electromagnetic relay configured to pull the movable contacts 10a, 10b toward the fixed contacts 6d, 7d.

1. An electromagnetic relay comprising:
a housing;
a pair of fixed terminals having a plate shape, the pair of fixed terminals each including an internal terminal located inside the housing, an external terminal including an external connection portion and protruding from the housing to an outside, and a fixed contact arranged on the internal terminal;
a movable contact piece including a pair of movable contacts arranged facing the fixed contact, the movable contact piece being configured to move in a moving direction including a contact direction in which the pair of movable contacts comes into contact with the fixed contact and a separation direction in which the pair of movable contacts separates from the fixed contact;
a drive shaft coupled to the movable contact piece; and
a drive device configured to move the contact piece through the drive shaft, wherein
the housing includes a side portion extending in the moving direction of the movable contact piece,
the external terminal is arranged without protruding outwardly in a width direction of the pair of fixed terminals beyond both ends of the side portion in the width direction of the pair of fixed terminals at a height position of the external terminal in the moving direction, and
the external connection portion is formed to be larger than the internal terminal in at least one of the width direction or a thickness direction of the pair of fixed terminals.

2. The electromagnetic relay according to claim 1, wherein
the external terminal includes a connection portion that connects the internal terminal and the external connection portion, and
a dimension of the connection portion in the width direction is smaller than a dimension of the external connection portion in the width direction.

3. The electromagnetic relay according to claim 1, wherein
the external terminal includes a connection portion that connects the internal terminal and the external connection portion, and
a dimension of the connection portion in the thickness direction is smaller than a dimension of the external connection portion in the thickness direction.

4. The electromagnetic relay according to claim 1, wherein
the external connection portion includes a fixing portion for fixing another terminal, and
the external connection portion has a contact area of 0.4 r or more around the fixing portion in a case where a radius of the fixing portion is defined as r.

5. The electromagnetic relay according to claim 4, wherein
the fixing portion is a circular hole penetrating in the thickness direction.

6. The electromagnetic relay according to claim 4, wherein
the fixing portion is a male screw portion extending in the thickness direction.
